(19) United States
(12) Patent Application Publication
(10) Pub. No.: US 2017/0207693 A1
(43) Pub. Date: Jul. 20, 2017

(54) PROTECTION SYSTEM AND METHOD FOR PHOTOVOLTAIC GRID-CONNECTED INVERTER

(71) Applicant: SUNGROW POWER SUPPLY CO., LTD., Hefei, Anhui (CN)

(72) Inventors: Houlai GENG, Hefei, Anhui (CN); Qingqing XU, Hefei, Anhui (CN); Jun XING, Hefei, Anhui (CN); Benhe YANG, Hefei, Anhui (CN); Haoyuan LI, Hefei, Anhui (CN); Xiaodong MEI, Hefei, Anhui (CN)

(21) Appl. No.: 15/324,101

(22) PCT Filed: Aug. 4, 2014
(86) PCT No.: PCT/CN2014/083622

§ 371 Date: Jan. 5, 2017

(51) Int. Cl. H02M 1/32; H02M 7/44; H02J 3/38

(52) U.S. Cl. CPC H02M 1/32; H02J 3/383; H02M 7/44

(57) ABSTRACT

A system for protecting a grid-connected photovoltaic inverter may include a detection device, a photovoltaic panel, an inverter, a transformer and an inverter controller. An output terminal of the photovoltaic panel is connected to an input terminal of the inverter, the inverter inverts a direct current into an alternating current and transmits it to the transformer a secondary side of the transformer is connected to an output terminal of the inverter, and a primary side is connected to a power grid. The primary side of the transformer is star-connected, and a neutral point is grounded. The detection device is connected between the primary side and the power grid, and is configured to detect whether a single-phase open-circuit fault occurs at the primary side and transmit a fault signal to the inverter controller. The inverter controller is configured to control the inverter to stop according to the fault signal.

### TECHNICAL FIELD

The present disclosure relates to the technical field of photovoltaic power generation, and in particular to a system and a method for protecting a grid-connected photovoltaic inverter.

### BACKGROUND

With the growing shortage of energy resources in the world, more and more regions begin to make use of photovoltaic power generation presently. Since electric energy outputted by a photovoltaic panel is a direct current, the direct current is required to be inverted to an alternating current via an inverter, the alternating current is fed to a power grid, and this process is called inverting and grid-connecting.

Generally, for isolation, a transformer is connected between the inverter and the power grid, and a photovoltaic grid-connected system having a transformer is introduced below in conjunction with a drawing.

Reference is made to FIG. 1, which is a schematic diagram of a grid-connected photovoltaic system having a transformer in conventional technology.

PV shown in FIG. 1 is a photovoltaic panel, an output of PV is a direct current, the direct current is inverted into an alternating current via an inverter 100, and the energy of the alternating current is transmitted to a power grid after the alternating current is isolated via a transformer T.

For ease of description, the side of the transformer T connected to the power grid is defined as a primary side (A, B, C), and the side of the transformer T connected to the inverter 100 is defined as a secondary side (a, b, c).

It should be noted that three phases at the primary side (A, B, C) of the transformer T are connected in a star shape, and a neutral point N is grounded. In such a connection mode, when an open-circuit fault occurs to any of the three phases at the primary side of the transformer T, i.e., at the power grid side, a voltage, a frequency, and a phase of the secondary side of the transformer T nearly have no difference from those in a normal state. That is, when a fault occurs at the primary side of the transformer T, the secondary side of the transformer T cannot sense the fault, thus, the inverter continues operating. However, since a fault occurs, the fault may cause an overcurrent problem to the transformer, and finally causes damage to the transformer.

Therefore, a system and a method for protecting a grid-connected photovoltaic inverter need to be provided by those skilled in the art, which can protect a grid-connected photovoltaic inverter and a transformer timely when a fault occurs to a power grid.

### SUMMARY

A system and a method for protecting a grid-connected photovoltaic inverter are provided according to the present disclosure, which can protect a grid-connected photovoltaic inverter and a transformer timely when a fault occurs to a power grid.

A system for protecting a grid-connected photovoltaic inverter is provided according to an embodiment, which includes: a detection device, a photovoltaic panel, an inverter, a transformer and an inverter controller,

where an output terminal of the photovoltaic panel is connected to an input terminal of the inverter, the inverter inverts a direct current outputted by the photovoltaic panel into an alternating current and transmits the alternating current to the transformer, a secondary side of the transformer is connected to an output terminal of the inverter, and a primary side of the transformer is connected to a power grid;

the primary side of the transformer is star-connected, and a neutral point of the primary side is grounded;

the detection device is connected between the primary side of the transformer and the power grid;

the detection device is configured to detect whether a single-phase open-circuit fault occurs at the primary side of the transformer, and transmit a fault signal to the inverter controller in a case that a single-phase open-circuit fault occurs at the primary side of the transformer; and

the inverter controller is configured to control the inverter to stop according to the fault signal.

Preferably, in detecting whether a single-phase open-circuit fault occurs at the primary side of the transformer, the detection device is specifically configured to:

determine whether a single-phase open-circuit fault occurs at the primary side by detecting whether a three-phase current of the primary side of the transformer is unbalanced; or

determine whether a single-phase open-circuit fault occurs at the primary side by detecting a current flowing through an N line of the primary side of the transformer.

Preferably, in a case that the number of the inverter is more than one, input terminals of the multiple inverters are respectively connected to corresponding photovoltaic panels, and output terminals of all the multiple inverters are connected to an input terminal of the transformer;

the system further includes a master controller, where the master controller is connected to inverter controllers corresponding to all the multiple inverters and the inverter controllers corresponding to the multiple inverters function as slave controllers.

transmitting the fault signal to the inverter controller by the detection device includes: transmitting, by the detection device, the fault signal to the master controller; and transmitting, by the master controller, the fault signal to the inverter controllers.

the inverter controllers are configured to control all the multiple inverters to stop according the fault signal.

Preferably, in a case that the number of the inverter is more than one, each of the multiple inverters corresponds to one inverter controller;

an input terminal of each of the multiple inverters is connected to a corresponding photovoltaic panel;

output terminals of all the multiple inverters are connected to an input terminal of the transformer;

the detection device transmits a fault signal to all the inverter controllers, when detecting that a single-phase open-circuit fault occurs at the primary side of the transformer; and

each of the inverter controllers is configured to control a corresponding inverter to stop according to the fault signal.

Preferably, the secondary side of the transformer is delta-connected; or the secondary side of the transformer is star-connected, and a neutral point thereof is grounded; or the secondary side of the transformer is star-connected, and the neutral point thereof is not grounded.

Preferably, the detection device transmits the fault signal to the inverter controller via a wired or a wireless connection.

A method for protecting a grid-connected photovoltaic inverter is provided according to an embodiment of the present disclosure, which is applied to a grid-connected photovoltaic system. The grid-connected photovoltaic system includes a photovoltaic panel, an inverter, a transformer and a controller, where an output terminal of the photovoltaic panel is connected to an input terminal of the inverter, the inverter inverts a direct current outputted by the photovoltaic panel into an alternating current and transmits the alternating current to the transformer, a secondary side of the transformer is connected to an output terminal of the inverter, and a primary side of the transformer is connected to a power grid; and the primary side of the transformer is star-connected, and a neutral point of the primary side is grounded.

The method includes the following steps:

detecting whether a single-phase open-circuit fault occurs at the primary side of the transformer; and

controlling the inverter to stop, in a case that a single-phase open-circuit fault occurs at the primary side of the transformer.

Preferably, the detecting whether a single-phase open-circuit fault occurs at the primary side of the transformer includes:

determining whether a single-phase open-circuit fault occurs at the primary side by detecting whether a three-phase current of the primary side of the transformer is unbalanced; or

determining whether a single-phase open-circuit fault occurs at the primary side by detecting a leakage current of the primary side of the transformer.

Preferably, the secondary side of the transformer is delta-connected; or the secondary side of the transformer is star-connected, and a neutral point thereof is grounded; or the secondary side of the transformer is star-connected, and the neutral point thereof is not grounded.

Preferably, in a case that the number of the inverter is more than one, all the multiple inverters are controlled to stop.

Compared with conventional technology, the present disclosure has the following advantages.

In the system according to the embodiment, the detection device, which can detect whether a single-phase open-circuit fault occurs at the primary side of the transformer, is arranged between the primary side of the transformer and the power grid. In a case that a single-phase open-circuit fault occurs, the detection device transmits a fault signal to a controller located at the inverter, and the controller controls the inverter to stop after receiving the fault signal. In this way, an overcurrent problem due to the fact that the inverter at the secondary side of the transformer is still operating after a fault has occurred at the primary side of the transformer can be prevented, thereby avoiding damage to the transformer.

### BRIEF DESCRIPTION OF THE DRAWINGS

Drawings to be used in description of embodiments or conventional technology are described briefly hereinafter, so that technical solutions according to the embodiments of the present disclosure or in conventional technology can be clearer. Apparently, the drawings described hereinafter only show some embodiments of the invention, and other drawings may be obtained by persons of ordinary skill in the art based on these drawings without any creative efforts.

FIG. 1 is a schematic diagram of a grid-connected photovoltaic system having a transformer in conventional technology;

FIG. 2 is a schematic diagram of a system for protecting a grid-connected photovoltaic inverter according to a first embodiment of the present disclosure;

FIG. 3A is a schematic diagram of a first connection of a primary side and a secondary side of a transformer T according to the present disclosure;

FIG. 3B is a schematic diagram of a second connection mode of a primary side and a secondary side of a transformer T according to the present disclosure;

FIG. 3C is a schematic diagram of a third connection mode of a primary side and a secondary side of a transformer T according to the present disclosure;

FIG. 4 is a schematic diagram of a system for protecting a grid-connected photovoltaic inverter according to a second embodiment of the present disclosure;

FIG. 5 is a schematic diagram of a system for protecting a grid-connected photovoltaic inverter according to a third embodiment of the present disclosure;

FIG. 6 is a flow chart of a method for protecting a grid-connected photovoltaic inverter according to a first embodiment of the present disclosure; and

FIG. 7 is a flow chart of a method for protecting a grid-connected photovoltaic inverter according to a second embodiment of the present disclosure.

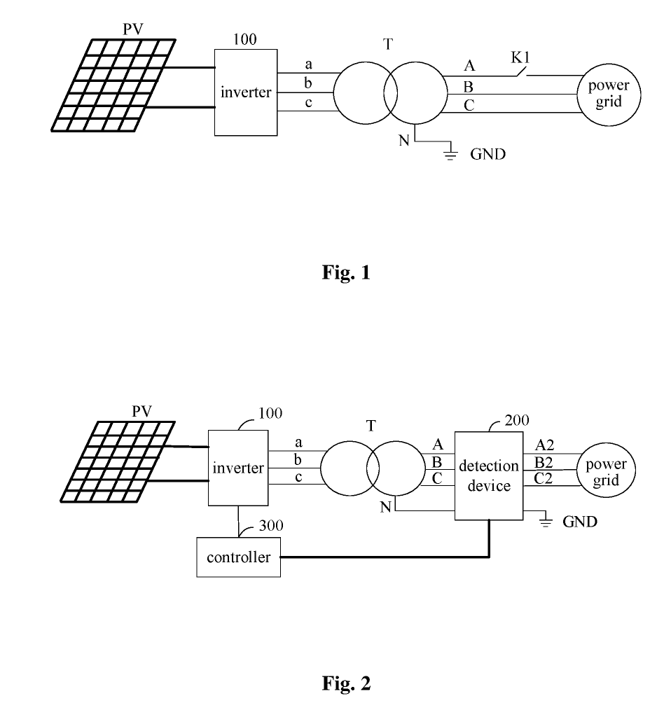

### DETAILED DESCRIPTION OF THE EMBODIMENTS

Hereinafter technical solutions according to the embodiments of the present disclosure are described clearly and completely in conjunction with the following drawings of the embodiments of the disclosure. Apparently, the described embodiments are merely a few rather than all of the embodiments of the invention. All other embodiments obtained by persons of ordinary skill in the art based on the embodiments of the present disclosure without any creative efforts shall fall within the protection scope of the present disclosure.

In order for a clear and easy understanding of the above objects, features and advantages of the present disclosure, some specific embodiments of the invention are described hereinafter in detail in conjunction with the drawings.

### First Embodiment of a System

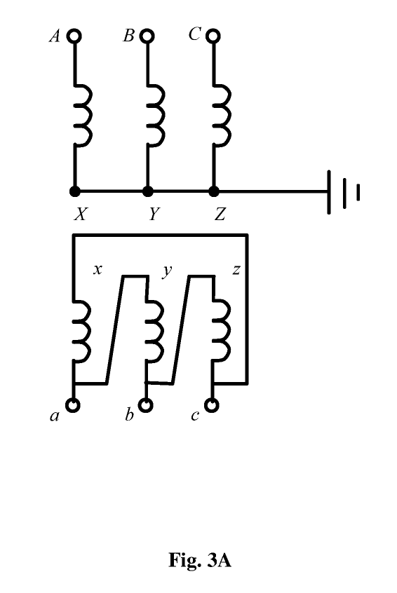

Reference is made to FIG. 2, which is schematic diagram of a system for protecting a grid-connected photovoltaic inverter according to a first embodiment of the present disclosure.

The system for protecting a grid-connected photovoltaic inverter according to the embodiment includes: a detection device 200, a photovoltaic panel PV, an inverter 100, a transformer T and an inverter controller 300,

where an output terminal of the photovoltaic panel PV is connected to an input terminal of the inverter 100, the inverter 100 inverts a direct current outputted by the photovoltaic panel PV into an alternating current and transmits the alternating current to the transformer T, a secondary side of the transformer T is connected to an output terminal of the inverter 100, and a primary side of the transformer T is connected to a power grid; and

the primary side of the transformer T is star-connected, and a neutral point of the primary side is grounded.

It should be noted that since the primary side of the transformer T is star-connected and the neutral point of the primary side is grounded, when a single-phase open-circuit fault occurs at the primary side of the transformer T, the secondary side of the transformer T will not be influenced, and a voltage, a frequency and a phase of the secondary side of the transformer T nearly remain unchanged. Therefore, the inverter 100 located at the secondary side of the transformer T can not sense that the single-phase open-circuit fault has occurred at the primary side of the transformer T. In this case, if the inverter 100 continues operating, an overcurrent problem may be caused. Accordingly, in the solution according to the embodiment, whether a fault occurs at the primary side of the transformer T is detected, and fault information is fed back to the secondary side of the transformer T to control the inverter 100 to stop.

The detection device 200 is connected between the primary side of the transformer T and the power grid, and configured to detect whether a single-phase open-circuit fault occurs at the primary side of the transformer T and transmit a fault signal to the inverter controller 300 in a case that a single-phase open-circuit fault occurs at the primary side of the transformer T.

It can be well understood that the inverter controller 300 is generally integrated together with the inverter 100.

It should be noted that a turn-off device is arranged at A2, B2 and C2, which may be a fuse or an air switch. For example, the turn-off device is a fuse, and when an overcurrent occurs to a phase at the primary side of the transformer T, the fuse will be burnt out. In this case, the detection device 200 can detect the single-phase open-circuit fault which occurs at the primary side of the transformer T.

It should be noted that other types of faults, such as incorrect phase sequence, overvoltage, under voltage and overcurrent, can be detected at the inverter side, i.e., the secondary side of the transformer. Therefore, the embodiment does not focus on those cases. It can be well understood that it is also required to control the inverter to stop when those faults occur.

Since the inverter controller 300 is a controller of the inverter, the inverter controller 300 is generally integrated together with the inverter 100. As a result, when a fault occurs at the primary side of the transformer T, the controller 300 can not sense the fault, and the detection device 200 is required to send a detection result to the inverter controller 300.

The inverter controller 300 is configured to control the inverter 100 to stop according to the fault signal.

The inverter controller 300 control the inverter 100 to stop in time when a fault occurs at the primary side of the transformer T, thereby protecting the transformer T.

In the system according to the embodiment, the detection device 200, which can detect whether a single-phase open-circuit fault occurs at the primary side of the transformer, is arranged between the primary side of the transformer T and the power grid. In a case that a single-phase open-circuit fault occurs, the detection device 200 transmits a fault signal to the inverter controller 300 located at the inverter 100, and the inverter controller 300 controls the inverter 100 to stop after receiving the fault signal. In this way, an overcurrent problem due to the fact that the inverter 100 at the secondary side of the transformer is still operating after a fault has occurred at the primary side of the transformer can be prevented, thereby avoiding damage to the inverter 100 the transformer T.

A connection mode of the secondary side of the transformer T is not specifically limited in the embodiment of the present disclosure and may be varied, which is described in detail hereinafter.

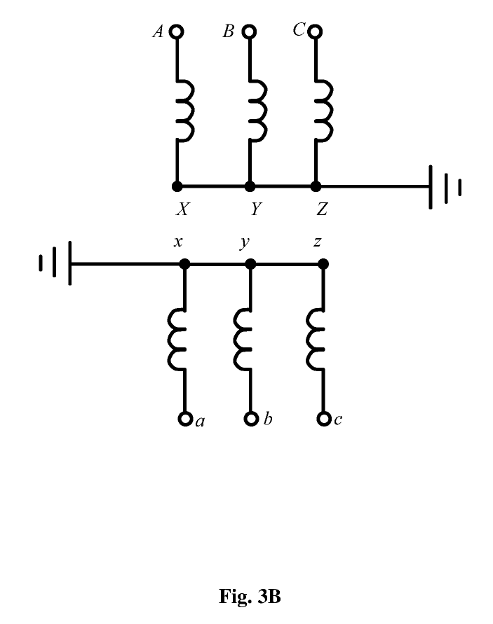

It should be noted that connection modes of the primary side of the transformer in FIG. 3A, FIG. 3B and FIG. 3C are the same, in which star-shaped connections are used and neutral points are grounded.

Reference is made to FIG. 3A, which is a schematic diagram of a first connection mode of the primary side and the secondary side of the transformer T according to the present disclosure.

The secondary side of the transformer in FIG. 3A is delta-connected.

It can be seen from FIG. 3A that three phase windings of the secondary side of the transformer are represented by lowercases x, y, z. It can be seen that x, y, z are connected head-to-tail in sequence to form a triangle, which is called delta-connection.

Reference is made to FIG. 3B, which is a schematic diagram of a second connection mode of the primary side and the secondary side of the transformer T according to the present disclosure.

Connection modes of the secondary side and the primary side of the transformer in FIG. 3B are the same, in which star-shaped connections are used and neutral points are grounded.

Reference is made to FIG. 3C, which is a schematic diagram of a third connection mode of the primary side and the secondary side of the transformer T according to the present disclosure.

The secondary side of the transformer in FIG. 3C is star-connected, and a neutral point thereof is not grounded.

It should be noted that several connection modes of windings of the primary side and the secondary side of the transformer are listed in the above, to which the embodiment of the present disclosure is not limited. In addition, the embodiment of the present disclosure does not limit a dotted terminal. For example, dotted terminals may be Aa, Ba, Cc, and dotted terminals of a transformer may be YD11, where Y represents that the primary side is star-connected, and D represents that the secondary side is delta-connected.

### Second Embodiment of a System

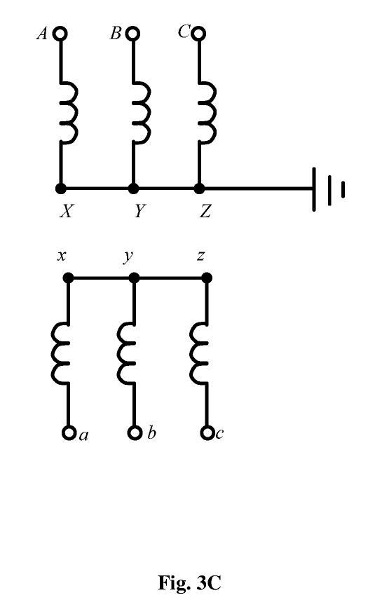

Reference is made to FIG. 4, which is a schematic diagram of a system for protecting a grid-connected photovoltaic inverter according to a second embodiment of the present disclosure.

The first system embodiment is described by taking an example of one inverter. It can be well understood that in practical operations, there are generally multiple inverters operating in parallel. Operation principles when multiple inverters operate in parallel are described in the embodiment.

FIG. 4 takes an example that n inverters operate in parallel, where n is an integer which is greater than or equal to 2. It can be well understood the number of the inverters being either 2 or more than 2 leads to the understanding that there are multiple inverters operating in parallel. As long as there are multiple inverters operating in parallel, operation principles thereof are the same. The number of the multiple inverters is not specifically limited in the present disclosure.

In the embodiment, in a case that there are multiple inverters, each of the multiple inverters corresponds to a controller. As shown in FIG. 4, a first inverter 100-1 corresponds to a first inverter controller 300-1, a second inverter 100-2 corresponds to a second inverter controller 300-2, and an n^{th} inverter 100-n corresponds to an n^{th} inverter controller 300-n.

Input terminals of the multiple inverters are respectively connected to corresponding photovoltaic panels. As shown in FIG. 4, an input terminal of the first inverter 100-1 is connected to PV1, an input terminal of the second inverter 100-2 is connected to PV2, and an input terminal of the n^{th} inverter 100-n is connected to PVn.

Output terminals of all the multiple inverters are connected to the secondary side of the transformer T. As shown in FIG. 4, the primary side of the transformer T is A, B and C, and the secondary side of the transformer T is a, b, and c.

The detection device 200 transmits a fault signal to all the controllers, when detecting that a single-phase open-circuit fault occurs at the primary side of the transformer T, that is, the detection device 200 is connected to all the controllers. As shown in FIG. 4, the detection device 200 is connected to the first inverter controller 300-1, the second inverter controller 300-2 and the n^{th} inverter controller 300-n.

Each of the controllers is configured to control a corresponding inverter to stop according to the fault signal. As shown in FIG. 4, the first inverter controller 300-1 controls the first inverter 100-1, the second inverter controller 300-2 controls the second inverter 100-2, and the n^{th} inverter controller 300-n controls the n^{th} inverter 100-n.

It should be noted that the detection device 200 can adopt a three-phase current unbalanced detection method, a leakage detection method, or other methods which can detect a phase failure, and certainly can also assist in functions, such as phase default detection, phase sequence detection and overcurrent detection. A main function of the detection device 200 is to detect a high unbalanced current or a great abnormal value of a current flowing through the N line, when a single phase disconnection occurs to a power grid.

For example, it is determined whether a single-phase open-circuit fault occurs at the primary side of the transformer by detecting whether a three-phase current of the primary side of the transformer is unbalanced. For example, if phase A is open, a current of phase A is 0, and currents of phase B and phase C will increase. Therefore, a large unbalance of currents occurs, for example, an unbalance occurs between phase A and phase B, and an unbalance occurs between phase A and phase C.

Alternatively, it is determined whether a single-phase open-circuit fault occurs at the primary side by detecting a current flowing through the N line of the primary side of the transformer, as the current flowing through the N line will change greatly if any of the phases is open.

It should be noted that the detection device may be connected between the transformer T and the power grid in series or in parallel.

It should also be noted that the detection device may transmit the fault signal to the inverter controller via a wired or a wireless connection.

The system for protecting a grid-connected photovoltaic inverter according to the embodiment detects that a fault occurs at the primary side of the transformer T by the detection device 200, and transmits a fault signal to all the controllers located at the secondary side of the transformer T, for all the controllers respectively to control corresponding inverters to stop, thereby, protecting all the inverters.

### Third Embodiment of a System

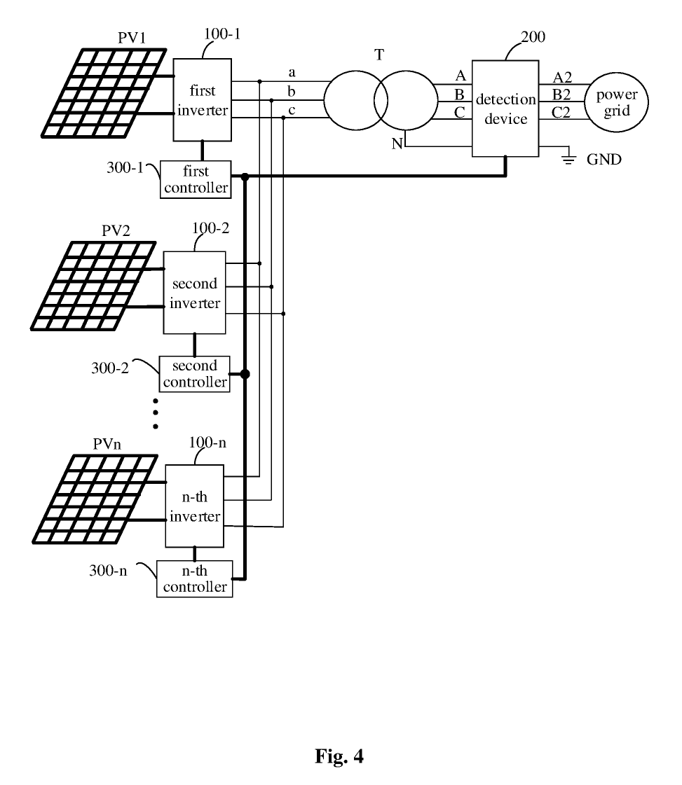

Reference is made to FIG. 5, which is schematic diagram of a system for protecting a grid-connected photovoltaic inverter according to a third embodiment of the present disclosure.

In the second system embodiment, the detection device directly transmits the fault signal to the inverter controllers corresponding to all the inverters. The embodiment differs from the second system embodiment in that all the inverters in the embodiment share one master controller, where the detection device first transmits the fault signal to the master controller, then the master controller transmits the fault signal to each inverter controller and in this case, each inverter controller is a slave controller, as shown in FIG. 5.

It can be well understood that generally, each inverter controller is integrated together with a corresponding inverter.

All inverter controllers corresponding to the first inverter 100-1, the second inverter 100-2, till the n^{th} inverter 100-n are connected to a master controller 400.

In a case that the detection device 200 detects a single-phase open-circuit fault occurs at the primary side of the transformer T, the detection device 200 transmits a fault signal to the master controller 400. The master controller 400 transmits the fault signal to all the slave controllers, namely, the first inverter controller 300-1, the second inverter controller 300-2, till the n^{th} inverter controller 300-n, and then each inverter controller controls a corresponding inverter to stop.

Based on the system for protecting a grid-connected photovoltaic inverter according to the above embodiments, a method for protecting a grid-connected photovoltaic inverter is further provided according an embodiment of the present disclosure, and operating processes of the method are described below in conjunction with drawings.

### First Embodiment of a Method

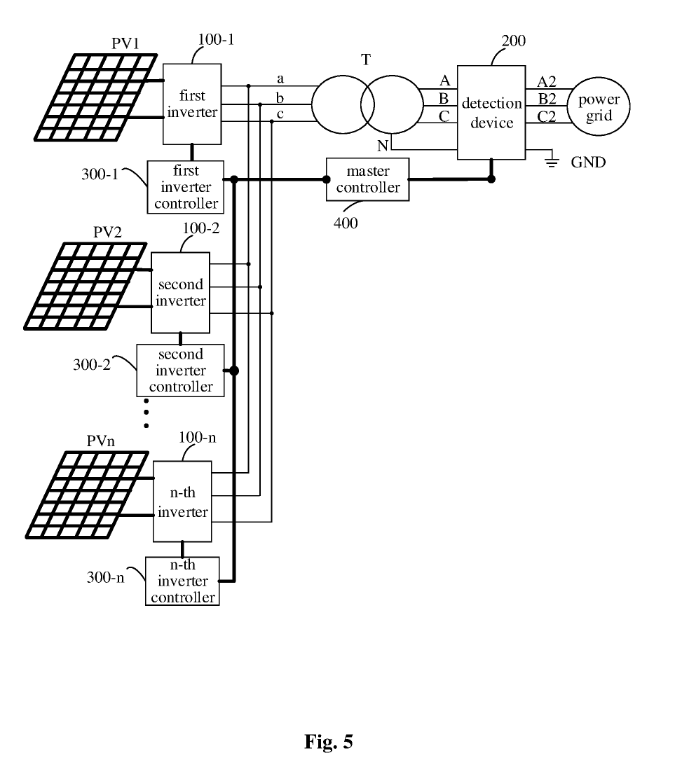

Reference is made to FIG. 6, which is a flow chart of a method for protecting a grid-connected photovoltaic inverter according to an embodiment of the present disclosure.

The method for protecting a grid-connected photovoltaic inverter according to the embodiment is applied to a grid-connected photovoltaic system, and the grid-connected photovoltaic system includes a photovoltaic panel, an inverter, a transformer and a controller, where an output terminal of the photovoltaic panel is connected to an input terminal of the inverter, the inverter inverts a direct current outputted by the photovoltaic panel into an alternating current and transmits the alternating current to the transformer, a secondary side of the transformer is connected to an output terminal of the inverter, and a primary side of the transformer is connected to a power grid; and the primary side of the transformer is star-connected, and a neutral point of the primary side is grounded. The method includes the following steps:

S601, detecting whether a single-phase open-circuit fault occurs at the primary side of the transformer; and

S602, controlling the inverter to stop, in a case that a single-phase open-circuit fault occurs at the primary side of the transformer.

It should be noted that since the primary side of the transformer is star-connected and the neutral point of the primary side is grounded, when a single-phase open-circuit fault occurs at the primary side of the transformer, the secondary side of the transformer T will not be influenced, and a voltage, a frequency and a phase of the secondary side of the transformer nearly remain unchanged. Therefore, the inverter located at the secondary side of the transformer can not sense that the single-phase open-circuit fault has occurred at the primary side of the transformer. In this case, if the inverter continues operating, an overcurrent problem may be caused. Accordingly, in the solution according to the embodiment, whether a fault occurs at the primary side of the transformer is detected, and fault information is fed back to the secondary side of the transformer to control the inverter to stop.

The inverter is controlled to stop in time, when a single-phase open-circuit fault occurs at the primary side of the transformer, thus, the transformer can be protected.

In the system according to the embodiment, whether a single-phase open-circuit fault occurs at the primary side of the transformer can be detected at the primary side of the transformer, and the controller controls the inverter to stop in a case that a single-phase open-circuit fault occurs. In this way, an overcurrent problem due to the fact that the inverter at the secondary side of the transformer is still operating after a fault has occurred at the primary side of the transformer can be prevented, thereby, avoiding damage to the transformer.

It should be noted that the secondary side of the transformer may be delta-connected.

In addition, the secondary side of the transformer may be star-connected, and a neutral point thereof is grounded; or the secondary side of the transformer may be star-connected, and the neutral point thereof is not grounded.

Reference can be made to FIGS. 3A to 3C for detailed connection modes of the secondary side of the transformer.

### Second Embodiment of a Method

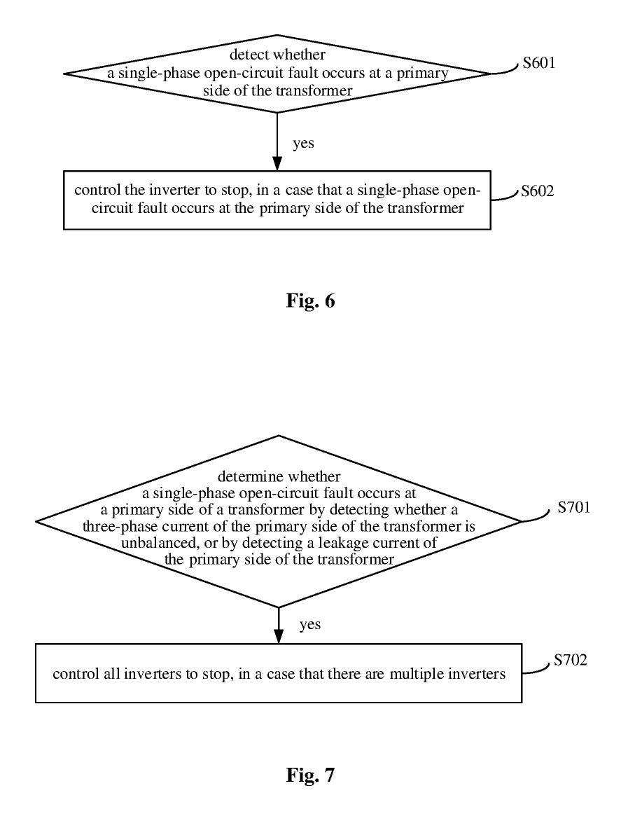

Reference is made to FIG. 7, which is a flow chart of a method for protecting a grid-connected photovoltaic inverter according to an embodiment of the present disclosure. The method includes steps S701 and S702.

In step S701, it is determined whether a single-phase open-circuit fault occurs at a primary side of a transformer by detecting whether a three-phase current of the primary side of the transformer is unbalanced, or by detecting a leakage current of the primary side of the transformer, and if so, S702 is executed.

It should be noted that the detection device can adopt a three-phase current unbalanced detection method, a leakage detection method, or other methods which can detect a phase failure, and certainly can also assist in functions, such as phase default detection, phase sequence detection and overcurrent detection. A main function of the detection device is to detect a high unbalanced current or a great abnormal value of a current flowing through the N line, when a single phase disconnection occurs to a power grid.

In step 702, all inverters are controlled to stop, in a case that there are multiple inverters.

In the method for protecting a grid-connected photovoltaic inverter according to the embodiment, when that a fault occurs at the primary side of the transformer is detected, all the inverters at the secondary side of the transformer are controlled to stop to prevent an overcurrent problem, thereby, protecting all the inverters in time.

The above are only some preferred embodiments of the present invention, which shall not be interpreted as limiting the invention in any forms. The invention is disclosed through the preferred embodiments above which are not intended to limit the invention though. Those skilled in the art may make possible variations and modifications to the technical solutions of the present disclosure or modify the technical solutions into equivalent embodiments in view of the methods and technical content disclosed in the above without departing from the scope of the technical solutions of the present disclosure. Therefore, any simple changes, equivalents or modifications made to the above embodiments based on the technical principles of the present disclosure without departing from the content of the technical solutions of the present disclosure shall fall within the protection scope of the technical solutions of the present disclosure.

1. A system for protecting a grid-connected photovoltaic inverter, comprising: a detection device, a photovoltaic panel, an inverter, a transformer and an inverter controller, wherein,
an output terminal of the photovoltaic panel is connected to an input terminal of the inverter, the inverter inverts a direct current outputted by the photovoltaic panel into an alternating current and transmits the alternating current to the transformer, a secondary side of the transformer is connected to an output terminal of the inverter, and a primary side of the transformer is connected to a power grid;
the primary side of the transformer is star-connected, and a neutral point of the primary side is grounded;
the detection device is connected between the primary side of the transformer and the power grid;
the detection device is configured to detect whether a single-phase open-circuit fault occurs at the primary side of the transformer and transmit a fault signal to the inverter controller, in a case that a single-phase open-circuit fault occurs at the primary side of the transformer; and
the inverter controller is configured to control the inverter to stop according to the fault signal.

2. The system for protecting a grid-connected photovoltaic inverter according to claim 1, wherein in detecting whether a single-phase open-circuit fault occurs at the primary side of the transformer, the detection device is configured to:
determine whether a single-phase open-circuit fault occurs at the primary side by detecting whether a three-phase current of the primary side of the transformer is unbalanced; or
determining whether a single-phase open-circuit fault occurs on the primary side by detecting a current flowing through the N line of the primary side of the transformer.

3. The system for protecting a grid-connected photovoltaic inverter according to claim 1, wherein in a case that the number of the inverter is more than one, input terminals of the plurality of inverters are respectively connected to corresponding photovoltaic panels, and output terminals of all the plurality of inverters are connected to an input terminal of the transformer;
the system further comprises a master controller, the master controller is connected to inverter controllers corresponding to all the plurality of inverters, and the inverter controllers corresponding to the plurality of inverters function as slave controllers;
transmitting the fault signal to the inverter controller by the detection device comprises transmitting, by the detection device, the fault signal to the master controller, and transmitting, by the master controller, the fault signal to the inverter controllers; and
the inverter controllers are configured to control all the plurality of inverters to stop according to the fault signal.

4. The system for protecting a grid-connected photovoltaic inverter according to claim 1, wherein in a case that the number of the inverter is more than one, each of the plurality of inverters corresponds to one inverter controller;
an input terminal of each of the plurality of inverters is respectively connected to a corresponding photovoltaic panel;
output terminals of all the plurality of inverters are connected to an input terminal of the transformer;
the detection device transmits a fault signal to all the inverter controllers, when detecting that a single-phase open-circuit fault occurs at the primary side of the transformer; and
each of the inverter controllers is configured to control a corresponding inverter to stop according to the fault signal.

5. The system for protecting a grid-connected photovoltaic inverter according to claim 1, wherein the secondary side of the transformer is delta-connected; or the secondary side of the transformer is star-connected, and a neutral point of the secondary side is grounded; or the secondary side of the transformer is star-connected, and the neutral point is not grounded.

6. The system for protecting a grid-connected photovoltaic inverter according to claim 1, wherein the detection device transmits the fault signal to the inverter controller via a wired or a wireless connection.

7. A method for protecting a grid-connected photovoltaic inverter, applied to a grid-connected photovoltaic system comprising a photovoltaic panel, an inverter, a transformer and a controller, wherein an output terminal of the photovoltaic panel is connected to an input terminal of the inverter, the inverter inverts a direct current outputted by the photovoltaic panel into an alternating current and transmits the alternating current to the transformer, a secondary side of the transformer is connected to an output terminal of the inverter, a primary side of the transformer is connected to a power grid, the primary side of the transformer is star-connected and a neutral point of the primary side is grounded,
the method comprising:
detecting whether a single-phase open-circuit fault occurs at the primary side of the transformer; and
controlling the inverter to stop, in a case that a single-phase open-circuit fault occurs at the primary side of the transformer.

8. The method for protecting a grid-connected photovoltaic inverter according to claim 7, wherein the detecting whether a single-phase open-circuit fault occurs at the primary side of the transformer comprises:
determining whether a single-phase open-circuit fault occurs at the primary side by detecting whether a three-phase current of the primary side of the transformer is unbalanced; or
determining whether a single-phase open-circuit fault occurs at the primary side by detecting a leakage current of the primary side of the transformer.

9. The method for protecting a grid-connected photovoltaic inverter according to claim 7, wherein the secondary side of the transformer is delta-connected; or the secondary side of the transformer is star-connected, and a neutral point of the secondary side is grounded; or the secondary side of the transformer is star-connected, and the neutral point is not grounded.

10. The method for protecting a grid-connected photovoltaic inverter according to claim 7, wherein in a case that the number of the inverter is more than one, all the plurality of inverters are controlled to stop.

11. The system for protecting a grid-connected photovoltaic inverter according to claim 2, wherein in a case that the number of the inverter is more than one, input terminals of the plurality of inverters are respectively connected to corresponding photovoltaic panels, and output terminals of all the plurality of inverters are connected to an input terminal of the transformer;
the system further comprises a master controller, the master controller is connected to inverter controllers corresponding to all the plurality of inverters, and the inverter controllers corresponding to the plurality of inverters function as slave controllers;
transmitting the fault signal to the inverter controller by the detection device comprises transmitting, by the detection device, the fault signal to the master controller, and transmitting, by the master controller, the fault signal to the inverter controllers; and
the inverter controllers are configured to control all the plurality of inverters to stop according to the fault signal.

12. The system for protecting a grid-connected photovoltaic inverter according to claim 2, wherein in a case that the number of the inverter is more than one, each of the plurality of inverters corresponds to one inverter controller;
an input terminal of each of the plurality of inverters is respectively connected to a corresponding photovoltaic panel;
output terminals of all the plurality of inverters are connected to an input terminal of the transformer;
the detection device transmits a fault signal to all the inverter controllers, when detecting that a single-phase open-circuit fault occurs at the primary side of the transformer; and
each of the inverter controllers is configured to control a corresponding inverter to stop according to the fault signal.

13. The method for protecting a grid-connected photovoltaic inverter according to claim 8, wherein the secondary side of the transformer is delta-connected; or the secondary side of the transformer is star-connected, and a neutral point of the secondary side is grounded; or the secondary side of the transformer is star-connected, and the neutral point is not grounded.
